(19) United States
(12) Patent Application Publication
(10) Pub. No.: US 2008/0289340 A1
(43) Pub. Date: Nov. 27, 2008

(54) Combustor of a gas turbine engine

(75) Inventors: Takeo Oda, Kobe-shi (JP); Atsushi Horikawa, Akashi-shi (JP); Hideki Ogata, Kakogawa-shi (JP)

Correspondence Address: OLIFF & BERRIDGE, PLC, P.O. BOX 320850, ALEXANDRIA, VA, 22320-4850, US

(73) Assignee: KAWASAKI JUKOGYO KABUSHIKI KAISHA, KOBE-SHI (JP)

(21) Appl. No.: 12/068,735

(22) Filed: Feb. 11, 2008

(30) Foreign Application Priority Data
Feb. 15, 2007 (JP) 2007-035208

(51) Int. Cl. F02C 1/00

(52) U.S. Cl. 60/737

(57) ABSTRACT

The present invention provides a combustor of a gas turbine engine, including: a fuel spray portion configured to spray a fuel so as to create a diffusion combustion region in a combustion chamber; a pre-mixture supply portion configured to supply a pre-mixture gas including the fuel and an air so as to create a pre-mixture combustion region in the combustion chamber, the pre-mixture supply portion being positioned concentrically with the fuel spray portion so as to surround the fuel spray portion; and an annular separation portion disposed between a downstream end of the fuel spray portion and a downstream end of the pre-mixture supply portion so as to separate the diffusion combustion region and the pre-mixture combustion region from each other.

### CROSS REFERENCE TO RELATED APPLICATIONS

This application is based upon the prior Japanese Patent Application No. 2007-35208 filed on Feb. 15, 2007, the entire contents of which are incorporated herein by reference.

1. Technical Field

The present invention relates to a combustor for use in a gas turbine engine including a fuel injection structure of a composite combustion type comprising a combination of two combustion systems, i.e., a diffusion combustion system and a lean pre-mixture combustion system.

2. Background Art

For the gas turbine engine, in view of the environmental protection, strict criteria are applied, with respect to the composition of exhaust gases to be generated by combustion. In the criteria, reduction of harmful matters, such as nitrogen oxides (hereinafter, referred to as NOx), is greatly required. On the other hand, in the case of large-size gas turbines and/or engines for airplanes, from the requirements of reducing the fuel consumption and enhancing the output, the pressure ratio currently tends to be set higher. Associated with such a tendency, higher temperature and/or higher pressure operations are to be employed around the input port of the combustor. Therefore, due to such operations to elevate the temperature around the input port of the combustor, the combustion temperature may also tend to be higher, leading to further increase of NOx.

In recent years, a composite combustion method has been proposed, in which the lean pre-mixture combustion system that can effectively reduce the generation amount of NOx and the diffusion combustion system excellent in both of the ignition performance and the flame holding performance are combined together (see Patent Documents Nos. 1, 2, 3, 4, 5, 6 mentioned hereunder). In the lean pre-mixture combustion system, air and a fuel are mixed in advance so as to combust or bum the so-obtained mixed gas or mixture, with the fuel concentration of the gas being uniform. Thus, there should be no region where the flame temperature is locally elevated. In addition, the flame temperature can be lowered over the whole region due to the dilution of the fuel. Therefore, the amount of generation of NOx can be effectively reduced. However, because a great amount of air is mixed uniformly with the fuel, the local fuel concentration over the combustion region should be significantly low. Thus, the stability of combustion, especially under lower intensity combustion, may tend to be deteriorated. On the other hand, the diffusion combustion system is configured to perform combustion while diffusing and mixing the fuel and air. Therefore, flame failure of the combustion is not likely to occur even under lower intensity combustion, presenting a superior flame holding performance. Accordingly, the composite combustion system can ensure the stability of combustion, while starting the operation and/or operating under lower intensity combustion, due to its diffusion combustion region, while it can reduce the amount of generation of the NOx, under higher intensity combustion, due to its lean pre-mixture combustion region.

A combustor for the composite combustion system, as shown in FIG. 6, includes a fuel spray portion 61 adapted to spray a fuel so as to form the diffusion combustion region, due to the diffusion combustion system, in a combustion chamber 60, and a pre-mixture supply portion 62 shaped concentrically relative to the fuel spray portion 61 to surround the outer circumference of the fuel spray portion 61, and adapted for supplying a pre-mixture of a fuel and air so as to form the pre-mixture combustion region, due to the lean pre-mixture combustion system, in the combustion chamber 60. The combustor is configured to supply a fuel only from the fuel spray portion 61 while starting the operation and/or operating under a lower intensity combustion mode, whereas, on a higher intensity combustion mode, it supplies the fuel also from the pre-mixture supply portion 62, in addition to supplying of the fuel from the fuel spray portion 61. The fuel spray portion 61 includes a fuel atomizing portion 61a, which is adapted to change the fuel into particles suitable for combustion by utilizing shearing force of air, and a diffusion passage portion 61b disposed on the downstream side of the fuel atomizing portion 61a, adapted to reduce the speed of a mixture of the fuel and air to a speed suitable for the combustion, and having a spreading trumpet-like shape. In this case, it is intended to enhance the combustion efficiency, due to the diffusion combustion to be achieved by spreading the diffusion combustion region, by utilizing the diffusion passage portion 61b.

Patent Document 1: JP No. 5-87340 A

Patent Document 2: JP No. 2002-115847 A

Patent Document 3: JP No. 2002-139221 A

Patent Document 4: JP No. 2002-168449 A

Patent Document 5: JP No. 2003-4232 A

Patent Document 6: U.S. Pat. No. 6,389,815

In such a configuration described above, while the fuel is supplied only from the fuel spray portion 61 while starting the operation and/or operating under lower intensity combustion, only a great amount of air 64 is supplied into the combustion chamber 60 from the pre-mixture supply portion 62. Thus, as schematically shown in FIG. 6, diffusion combustion flame 63 is created by a mixed gas or mixture of the fuel and air introduced to spread over the entire space in the combustion chamber 60 along the diffusion passage portion 61b having a spreading trumpet-like shape. In this case, however, the air 64 to be supplied from the pre-mixture supply portion 62 will interfere with the outer circumferential region of the so-created diffusion combustion flame 63. The interferential range between the diffusion combustion flame 63 and the air 64 is schematically depicted in FIG. 6, by using lattice-like hatching. The influence of such interference makes the local fuel concentration significantly lower at the outer circumferential portion of the diffusion combustion region as well as makes it difficult to keep the fuel concentration range to be suitable for stable combustion. Thus, flame failure in the diffusion combustion flame 63 may tend to occur, leading to deterioration of the ignition performance, the flame holding performance, and the stability of combustion under lower intensity combustion.

In particular, in the case of gas turbine engines used for airplanes, secure ignition is required under the conditions of lower temperature and lower pressure at a higher altitude, and various restrictions are imposed, with regard to harmful exhaust matters, such as CO and/or THC (Total HC), under lower intensity combustion, including idling time. Therefore, the degradation of the ignition performance and stability of combustion, due to the great amount of air 64 supplied from the pre-mixture supply portion 62 may often be problematic.

### SUMMARY OF INVENTION

The present invention was made in light of the above challenges posed on the conventional art, and it is therefore an object thereof to provide a combustor for use in the gas turbine engine, the combustor having a structure of a composite combustion system comprising a combination of the two combustion systems, i.e., the diffusion combustion system and the lean pre-mixture combustion system, and being able to securely enhance the ignition performance, the flame holding performance, and the stability of combustion under lower intensity-combustion.

In order to achieve the above object, the combustor of a gas turbine engine according to the present invention,. including: a fuel spray portion configured to spray a fuel so as to create a diffusion combustion region in a combustion chamber; a pre-mixture supply portion configured to supply a pre-mixture gas including the fuel and an air so as to create a pre-mixture combustion region in the combustion chamber, the pre-mixture supply portion being positioned concentrically with the fuel spray portion so as to surround the fuel spray portion; and an annular separation portion disposed between a downstream end of the fuel spray portion and a downstream end of the pre-mixture supply portion so as to separate the diffusion combustion region and the pre-mixture combustion region from each other.

In this combustor, only the air may be supplied from the pre-mixture supply portion into the diffusion combustion region- while starting an operation of the engine and/or operating the engine under low intensity combustion.

In the present invention having the configuration described above, the diffusion combustion region and the pre-mixture combustion region can be separated from each other due to the annular separation portion disposed between the fuel spray portion and the pre-mixture supply portion. Therefore, while starting the operation and/or operating under lower intensity combustion, the diffusion combustion flame generated by the fuel injected from the fuel spray portion into the combustion chamber will not be mixed with a great amount of air supplied from the pre-mixture supply portion. Consequently, flame failure of the diffusion combustion flame due to the great amount of the air can be prevented, while the entire diffusion combustion region can be kept within a fuel concentration range suitable for stable combustion, thereby the ignition performance, flame holding performance and stable combustion can be significantly ensured under a lower intensity combustion mode.

In this invention, it is preferred that the combustor of a gas turbine engine further comprises air curtain forming means configured to inject a separating air between the diffusion combustion region and the pre-mixture combustion region through the annular separation portion so as to promote a separation between the regions. With this configuration, the air curtain can prevent, further effectively, the fuel supplied from the fuel spray portion from being mixed with the air to be used for the pre-mixture combustion, and the separating air can surely cool the separation portion to be exposed to the combustion flame.

In this invention, it is preferred that the annular separation portion has a width W in a radial direction, the pre-mixture supply portion includes an outer circumferential wall having an inner diameter D at a downstream end thereof, the width W being set between 0.13D to 0.25D. If the width W in the radial direction of the separation portion is less than 0.13D, the diffusion combustion region and the pre-mixture combustion region can not be effectively separated from each other, due to such a separation portion. Contrary, if the width W in the radial direction exceeds 0.25D, the diffusion combustion region would be too small. Thus the fuel would be injected focusing on the narrowed region, as such making the fuel not likely to be combusted, resulting in deterioration of the stability of combustion.

In this invention, it is preferred that the fuel spray portion includes a fuel atomizing portion configured to atomize the fuel, and a diffusion passage portion disposed downstream of the fuel atomizing portion, the diffusion passage portion having a spreading trumpet-like shape and being configured to diffuse the fuel and the air. With this configuration, since the mixture of the fuel and air can be injected into the combustion chamber while well spreading due to the diffusion passage portion having a spreading trumpet-like shape, the mixture can be well combustible, thus enhancing the stability of combustion in the diffusion combustion region.

As mentioned above, according to the combustor for use in the gas turbine engine of this invention, the diffusion combustion region and the pre-mixture combustion region can be separated from each other due to the separation portion disposed between the fuel spray portion and the pre-mixture supply portion. Therefore, mixing of the great amount of air supplied from the pre-mixture supply portion with the diffusion combustion flame created by the fuel supplied from the fuel spray portion can be prevented, while starting the operation and/or operating under lower intensity combustion. Consequently, flame failure of the diffusion combustion flame caused by such air can be avoided, while the entire diffusion combustion region can be kept in a fuel concentration range suitable for stable combustion, thereby the ignition performance, flame holding performance and stability of combustion can be significantly enhanced under a lower intensity combustion mode.

### BRIEF DESCRIPTION OF DRAWINGS

The above and other objects, features and advantages of the present invention will become more apparent from the following description taken in connection with the accompanying drawings, in which:

FIG. 1 is a schematic front view showing a combustor for use in a gas turbine engine according to a first embodiment of the present invention;

FIG. 2 is an enlarged section taken along line II-II of FIG. 1;

FIG. 3 is an enlarged longitudinal section showing details of a fuel injection unit in FIG. 2;

FIG. 4 includes graphs (a) and (b) showing profiles of actually measured values for the combustion efficiency relative to the air-fuel ratio, under the idling operation as well as under higher intensity combustion, in the same combustor;

FIG. 5 is a graph showing test results for ignition and flame failure, i.e., profiles of actually measured values of the air-fuel ratio, with respect to the pressure difference between an entrance and an exit of each fuel injection unit; and

FIG. 6 is a longitudinal section showing a conventional combustor for use in the gas turbine engine.

### DESCRIPTION OF EMBODIMENTS

Hereinafter, preferred embodiments of the present invention will be described with reference to the drawings.

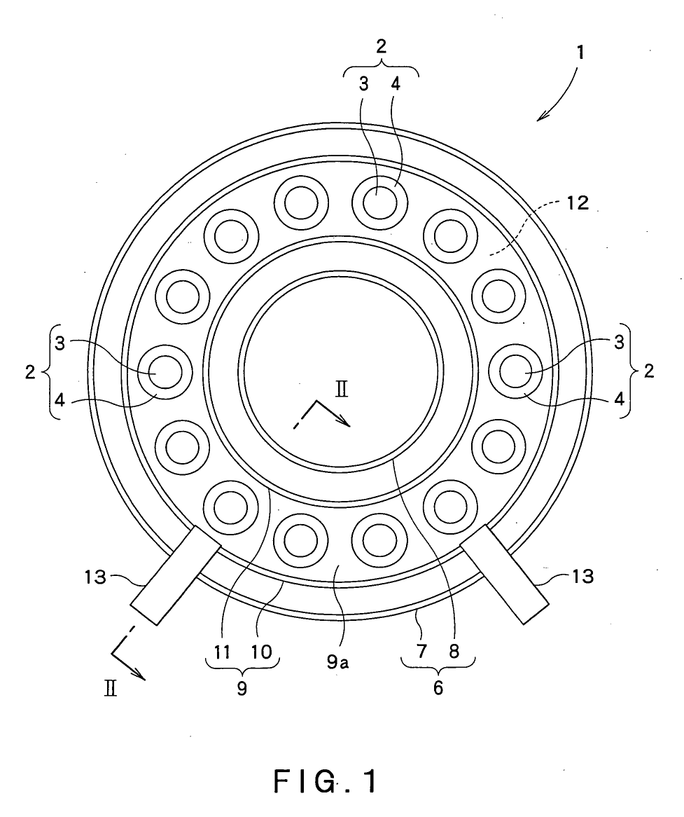

FIG. 1 shows a head of a combustor 1 for use in a gas turbine engine according to a first embodiment of the present invention. The combustor 1 is configured to drive a turbine, by combusting a mixed gas or mixture to be formed by mixing a fuel with compressed air supplied from a compressor (not shown) of the gas turbine engine, and then supplying the so-formed high-temperature and high-pressure combustion gas generated by the combustion to the turbine.

The combustor 1 is of an annular type, in which a combustor housing 6 having an annular internal space is constructed by arranging an annular inner casing 8 concentrically into an annular outer casing 7. In the annular internal space of the combustor housing 6, a combustion cylinder 9, which is constructed by arranging an annular inner liner 11 concentrically into an annular outer liner 10, is arranged concentrically with the combustor housing 6. The combustion cylinder 9 has an annular combustion chamber 12 formed therein. In a top wall 9a of the combustion cylinder 9, a plurality of (fourteen (14) in this embodiment) fuel injection units 2 each adapted to inject the fuel into the combustion chamber 12 are positioned concentrically with the combustion cylinder 9 at an equal interval, while arranged in a single circle. Each fuel injection unit 2 includes a fuel spray portion (pilot fuel injection nozzle) 3, and a pre-mixture supply portion (main fuel injection nozzle) 4 configured to surround the outer circumference of the fuel spray portion 3 and arranged concentrically with the fuel spray portion 3. The fuel spray portion 3 and pre-mixture supply portion 4 will be detailed later.

Through the outer casing 7 and outer liner 10, two spark plugs 13 adapted for ignition extend in the radial direction relative to the combustion cylinder 9, with the distal ends thereof being opposed to the fuel injection units 2. Accordingly, in the combustor 1, the combustible mixed gas injected from the two fuel injection units 2 opposed to the two spark plugs 13 is first ignited, and the flame generated due to the combustion then burns the combustible mixed gas injected from adjacent fuel injection units 2, after another. Finally, the flame transfers to and ignites the mixed gas injected from all the fuel injection units 2.

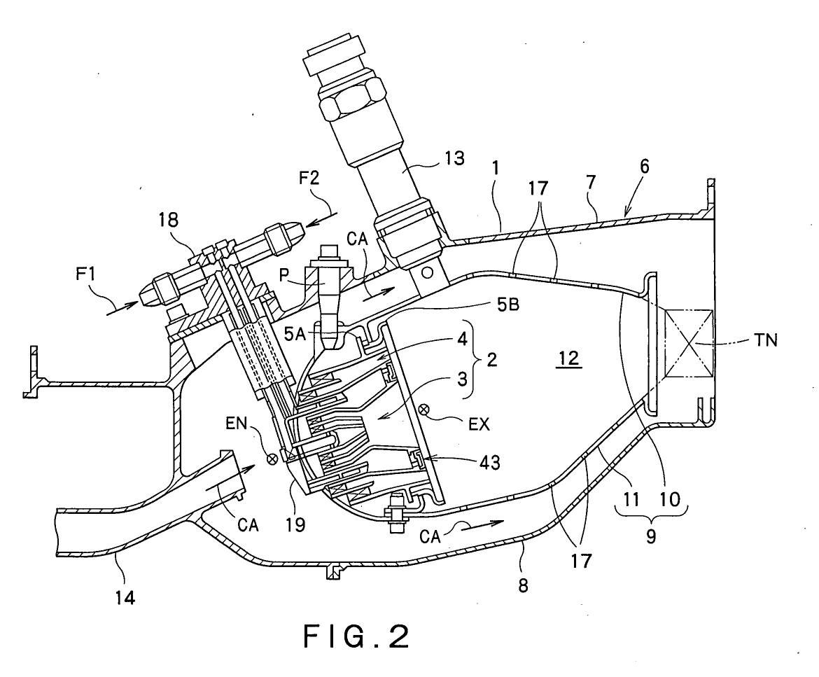

FIG. 2 is an enlarged longitudinal section taken along line II-II of FIG. 1. In the annular internal space of the combustor housing 6, compressed air CA supplied from the compressor is introduced via a plurality of air intake pipes 14. The compressed air CA introduced is then supplied into the fuel injection unit 2, while supplied into the combustion chamber 12 through air introduction ports 17 respectively formed in large numbers in the outer liner 10 and inner liner 11 of the combustion cylinder 9. A fuel piping unit 18, constituting a first fuel supply system F1 for supplying a fuel for diffusion combustion into the fuel spray portion 3 and a second fuel supply system F2 for supplying a fuel for lean pre-mixture combustion into the pre-mixture supply portion 4, is supported by the outer casing 7, and is connected with a base 19 of the combustion cylinder 9. Each fuel injection unit 2 is supported by the outer liner 10 via a flange 5A disposed on the outer circumferential portion of the fuel injection unit 2 and a support member 5B disposed-on the outer liner 10. The outer liner 10 is in turn supported by the outer casing 7 via a liner fixing pin P. A first stage nozzle TN of the turbine is connected with a downstream end of the combustion cylinder 9.

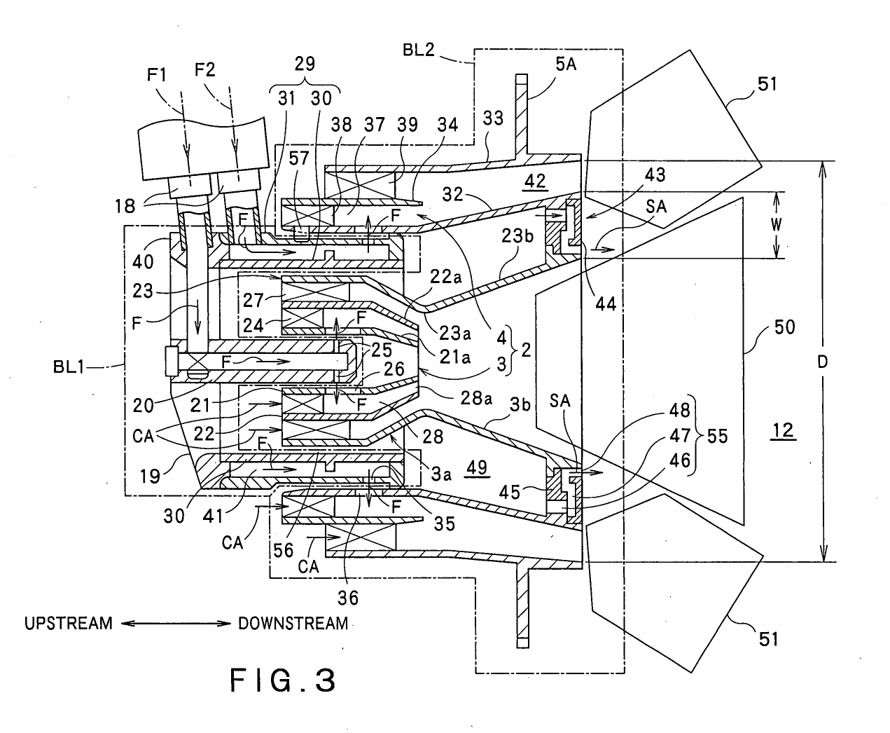

FIG. 3 is a longitudinal section showing the fuel injection unit 2 of FIG. 2 in more detail. The fuel spray portion 3 disposed at a central portion of the fuel injection unit 2 includes a cylindrical main body 20 having a bottom portion and adapted to supply the fuel F, for the diffusion combustion, fed from the first fuel supply system F1, a cylindrical inner circumferential wall 21 fitted around the main body 20, a cylindrical intermediate wall 22 arranged externally and concentrically relative to the cylindrical inner circumferential wall 21, a nozzle 23 of a Venturi nozzle type, arranged externally and concentrically relative to the cylindrical intermediate wall 22, a first inner swirler 24 disposed between the cylindrical inner circumferential wall 21 and the cylindrical intermediate wall 22, and a first outer swirler 27 disposed between the cylindrical intermediate wall 22 and the nozzle 23.

At a downstream end of the main body 20, a plurality of fuel injection holes 25 are formed radially to inject radially outward the fuel F supplied into the main body 20. In each point of the cylindrical inner circumferential wall 21 corresponding to the fuel injection holes 25, a fuel introduction hole 26 is formed for introducing the fuel F into a primary atomizing passage 28 formed between the cylindrical inner circumferential wall 21 and the cylindrical intermediate wall 22. The fuel F introduced into the primary atomizing passage 28 is then injected from an atomized fuel injection port 28a disposed on the downstream side.

The atomized fuel injection port 28a, i.e., the downstream end of each of the cylindrical inner circumferential wall 21 and cylindrical intermediate wall 22 is substantially coincident, in position along the axis of the combustor 1 (in the lateral direction in the drawing), with a throttling portion 23a, at which the inner diameter of the nozzle 23 is the minimum. A diameter spreading portion 23b extending downstream from the throttling portion 23a of the nozzle 23 is formed into a trumpet-like shape having a predetermined spreading angle. Thus, the fuel spray portion 3 includes a fuel atomizing portion 3a defined by a portion extending from an upstream end of the nozzle 23 up to the throttling portion 23a of the nozzle 23, and a diffusion passage portion 3b defined by a portion extending from the throttling portion 23a up to a downstream end of the nozzle 23, i.e., the diameter spreading portion 23b of the nozzle 23. The fuel atomizing portion 3a includes respective downstream ends 21a, 22a of the cylindrical inner circumferential wall 21 and cylindrical intermediate wall 22 constituting the primary atomizing passage 28. The downstream ends 21a, 22a are each formed into a tapered truncated conical shape, corresponding to the shape in the opposite position of the nozzle 23. Thus, the fuel atomizing portion 3a is configured to inject the fuel F from the primary atomizing passage 28 and the compressed air CA from the first outer swirler 27, respectively, toward the central axis of the main body 20, obliquely, in a layered state. Thereafter, the diffusion passage portion 3b disposed downstream of the fuel atomizing portion 3a injects the fuel F and the compressed air CA into the combustion chamber 12 at an injection angle defined by the diameter spreading portion 23b while diffusing the fuel F together with the compressed air CA.

With the fuel spray portion 3, the fuel F for the diffusion combustion is supplied from the first fuel supply system F1 in all the range of load or intensity, i.e., from the stage while starting the operation and/or operating under lower intensity combustion (50% or lower relative to the full load) up to the stage under higher intensity combustion (50% or higher relative to the full load). Specifically, in the fuel atomizing portion 3a, the fuel F supplied into the main body 20 is injected from each fuel injection hole 25, and the injected fuel F is then subjected to primary atomization due to the compressed air CA supplied from the first inner swirler 24. Thereafter, the fuel F having been subjected to the primary atomization is further subjected to secondary atomization due to a swirling air stream provided from the first outer swirler 27 in the diffusion passage portion 3b, thus being sprayed into the combustion chamber 12, as such creating a diffusion combustion region 50 in the combustion chamber 12.

Next, the pre-mixture supply portion 4 in a form of surrounding the outer circumference of the fuel spray portion 3 will be described. The pre-mixture supply portion 4 includes a cylindrical double-wall main body 29 including an inner cylindrical body 30 and an outer cylindrical body 31, a cylindrical intermediate wall 32 arranged externally and concentrically relative to the main body 29, a cylindrical outer circumferential wall 33 arranged externally and concentrically relative to the cylindrical intermediate wall 32, a cylindrical partition wall 34 for separating the cylindrical intermediate wall 32 from the cylindrical outer circumferential wall 33, a second inner swirler 38 located at an input port of a pre-mixture preparing chamber 37 disposed between the cylindrical intermediate wall 32 and the cylindrical partition wall 34, and a second outer swirler 39 disposed between the cylindrical partition wall 34 and the cylindrical outer circumferential wall 33. The main body 29 is supported by the base 19, externally to the fuel spray portion 3, with the opening at an upstream end between the cylindrical double walls of the main body 29 being closed by a cover-like portion 40 of the base 19. Thus, the fuel F, for the pre-mixture combustion, supplied from the second fuel supply system F2 can be introduced into the pre-mixture supply portion 4.

In the main body 29 of the pre-mixture supply portion 4, a fuel supply passage 41 is formed in a gap between the inner cylindrical body 30 and the outer cylindrical body 31. The fuel supply passage 41 is configured to supply the fuel F fed from the second fuel supply system F2 to a plurality of (for example, eight) fuel injection holes 35 respectively formed in the downstream circumferential wall of the outer cylindrical body 31 at a predetermined interval. In the cylindrical intermediate wall 32, fuel introduction holes 36, for guiding the fuel F injected from the respective fuel injection holes 35 into the pre-mixture preparing chamber 37, are formed. The cylindrical intermediate wall 32 covers approximately a half of the downstream part of the outer cylindrical body 31, and the downstream end of the wall 32 is coincident, in the axial position, with the downstream end of the nozzle 23 of the fuel spray portion 3. In addition, a pre-mixture chamber 42 is disposed on the downstream side of the cylindrical partition wall 34 and between the cylindrical intermediate wall 32 and the cylindrical outer circumferential wall 33. The upstream end of the cylindrical partition wall 34 is coincident, in the axial position, with the upstream end of the cylindrical intermediate wall 32. The length in the axial direction of the cylindrical partition wall 34 is set such that its downstream end is located downstream a predetermined distance relative to the fuel introduction hole 36. The upstream end of the cylindrical outer circumferential wall 33 is positioned downstream in the axial direction a predetermined distance relative to the upstream end of the cylindrical partition wall 34. The down stream end of the cylindrical outer circumferential wall 33 is set to be coincident, in the axial position, with the downstream end of the cylindrical intermediate wall 32.

To the pre-mixture supply portion 4, the fuel F is supplied from the second fuel supply system F2 only under higher intensity combustion as is greater than 50% or more relative to the full load. The fuel F is then injected into the pre-mixture preparing chamber 37, via the fuel injection holes 35 and the fuel introduction holes 36, through the fuel supply passage 41. Thereafter, the injected fuel F is subjected to the primary atomization due to the compressed air CA supplied from the second inner swirler 38. Subsequently, the fuel F having been subjected to the primary atomization is further subjected to the second atomization due to the swirling air stream provided from the second outer swirler 39 in the pre-mixture chamber 42. Consequently, the pre-mixture gas is produced, in which the fuel F and the compressed air CA are well mixed in advance. The pre-mixture gas is then supplied and combusted in the combustion chamber 12, thereby a pre-mixture combustion region 51 is created. It should be noted that since the fuel F is not supplied into the pre-mixture supply portion 4 under a lower intensity combustion mode as is lower than 50% or less relative to the full load, only a greater amount of the compressed air CA is supplied into the combustion chamber 12 in that mode.

In the combustor 1 of this embodiment, an annular separation portion 43 is disposed between the downstream end of the nozzle 23 of the fuel spray portion 3 and the downstream end of the cylindrical intermediate wall 32 of the pre-mixture supply portion 4. The separation portion 43 is adapted to separate the diffusion combustion region 50 created due to the fuel spray portion 3 from the pre-mixture combustion region 51 created due to the pre-mixture supply portion 4. The separation portion 43 includes an annular cover member 44 arranged to close a space defined between the respective downstream ends of the nozzle 23 and cylindrical intermediate wall 32, while separating these downstream ends from each other in the radial direction. A downstream face of the cover member 44 opposed to the combustion chamber 12 is a flat face extending along the radial direction.

An annular end member 45 is attached between the downstream end of the nozzle 23 and the downstream end of the cylindrical intermediate wall 32, and a plurality of air holes 46 are formed in the end member 45 along the circumferential direction at an equal interval. Between the cover member 44 and the end member 45, an air passage 47 communicating with each air hole 46 is formed. Additionally, an annular air injection port 48 communicating with the air passage 47 is disposed between the inner circumferential face of the cover member 44 and the downstream end of the diameter spreading portion 23b of the nozzle 23. An air accumulation chamber 49 is formed between the nozzle 23 and the cylindrical intermediate wall 32, and each air hole 46 is in communication with the air accumulation chamber 49. In this manner, an air curtain forming means 55 is constructed, by the air holes 46, air passage 47 and air injection port 48, the air curtain means 55 being adapted to inject the compressed air CA accumulated in the air accumulation chamber 49, as the separation air SA, between the diffusion combustion region 50 and the pre-mixture combustion region 51, through the separation portion 43, so as to promote the separation between the regions 50, 51.

With the configuration described above, while starting the operation and/or operating under a lower intensity combustion mode, the fuel F is supplied only to the fuel spray portion 3 located inside the fuel injection unit 2 from the first fuel supply system F1, and the fuel F is then diffused, together with the compressed air CA, by the diffusion passage portion 3b having a spreading trumpet-like shape in the fuel spray portion 3. Thereafter, the diffused mixture is injected into the combustion chamber while spreading, as such being likely to be combusted and thus providing excellent stability of combustion in the diffusion combustion region 50. At this time, spreading of the stream of the fuel F to be injected into the combustion chamber 12 from the diffusion passage portion 3b can be properly controlled. Consequently, as schematically shown in FIG. 3, mixing of a great amount of air supplied into the pre-mixture combustion region 51 with the flame created in the diffusion combustion region 50 due to the fuel F injected into the combustion chamber 12 from the fuel spray portion 3 can be prevented. In this manner, the diffusion combustion region 50 can be properly separated from the air fed in the pre-mixture combustion region 51, flame failure of the flame to be created in the diffusion combustion region 50 due to the great amount of air can be avoided. Additionally, the entire diffusion combustion region 50 can be kept in a suitable fuel concentration range for stabilized combustion. Thus, the ignition performance, flame holding performance as well as stability of combustion under lower intensity combustion can be significantly enhanced.

The separation portion 43 is designed to have a width W in the radial direction, as shown in FIG. 3, relative to the inner diameter D of the cylindrical outer circumferential wall 33 of the pre-mixture supply portion 4, within the range from 0.13D to 0.25D. More preferably, the width D is set within the range from 0.15D to 0.20D. If the width W in the radial direction of the separation portion 43 is less than 0.13D, the diffusion combustion region 50 and the pre-mixture combustion region 51 can not be effectively separated from each other. Contrary, if the width W in the radial direction exceeds 0.25D, the diffusion of the air to be used for the diffusion combustion would be insufficient, thus unduly increasing the flowing speed of the mixture of the fuel and air relative to the speed suitable for the combustion, as such making the mixture not likely to be combusted, resulting in deterioration of the stability of combustion. In addition, in the annular-type combustor 1, in which the plurality of fuel injection units 2 are arranged annularly as shown in FIG. 1, smooth transfer of the flame from one to another of the adjacent fuel injection units 2 can not be performed well.

Furthermore, in the combustor 1 described above, the air curtain forming means 55 is provided, adding to the separation portion 43. Consequently, the compressed air CA introduced into the air accumulation chamber 49 from an air introduction passage 56 formed between the nozzle 23 and the inner cylindrical body 30 can enter the air passage 47 via each air hole 46, cool the cover member 44, and then be injected into the combustion chamber 12 via the air injection port 48. The injected air can serve as separating air SA used for promoting the separation between the diffusion combustion region 50 and the pre-mixture combustion region 51 in the combustion chamber 12, i.e., used for creating an air curtain between the diffusion combustion region 50 and the pre-mixture combustion region 51. This air curtain can prevent a part of the fuel injected from the diffusion passage portion 3b from traveling along the separation portion 43 and then flowing into the pre-mixture combustion region 51, as well as further restrict spreading of the flame created in the diffusion combustion region 50, thus preventing, more securely, the great amount of air supplied externally to the flame in the diffusion combustion region 50 from being mixed with the flame. Besides, since a part of the fuel F sprayed from the diffusion passage portion 3b of the fuel spray portion 3 is further subjected to three-dimensional atomization due to the air for constituting the air curtain, more stabilized diffusion combustion can be achieved.

In the fuel spray portion 3, the first inner swirler 24, which is of a smaller size than that of the first outer swirler 27, is used, and thus the swirling function of the first inner swirler 24 is relatively low. Therefore, more secure control of the injection angle of the fuel injected from the diffusion passage portion 3b of the fuel spray portion 3 can be achieved, thus also leading to more enhanced stabilization for the diffusion combustion.

Furthermore, in the combustor 1 described above, the main body 20 of the fuel spray portion 3 and the main body 29 of the pre-mixture supply portion 4 are respectively connected with the base 19 so as to constitute together an-inner block BL1 as a single connected body. On the other hand, an outer block BL2 is constructed, as a single connected body, with members other than the main bodies 20, 29. Namely, the outer block BL2 is constructed by connecting the cylindrical intermediate wall 32 with the cylindrical partition wall 34 via the second inner swirler 38, connecting the cylindrical partition wall 34 with the cylindrical outer wall 33 via the second outer swirler 39, and connecting the cylindrical intermediate wall 32 with the nozzle 23 via the cover member 44. The inner block BL1 and the outer block BL2 are connected with each other, by fixing the cylindrical intermediate wall 32 and the outer cylindrical body 31 together, by means of fitting due to a predetermined number of pins 57.

Accordingly, by releasing the fitting between the cylindrical intermediate wall 32 and the outer cylindrical body 31, the outer block BL2 can be separated from the inner block BL1. Thus, maintenance and check for the apparatus can be performed, with only the inner block BL1 being withdrawn and removed from the combustion cylinder 9 shown in FIG. 2.

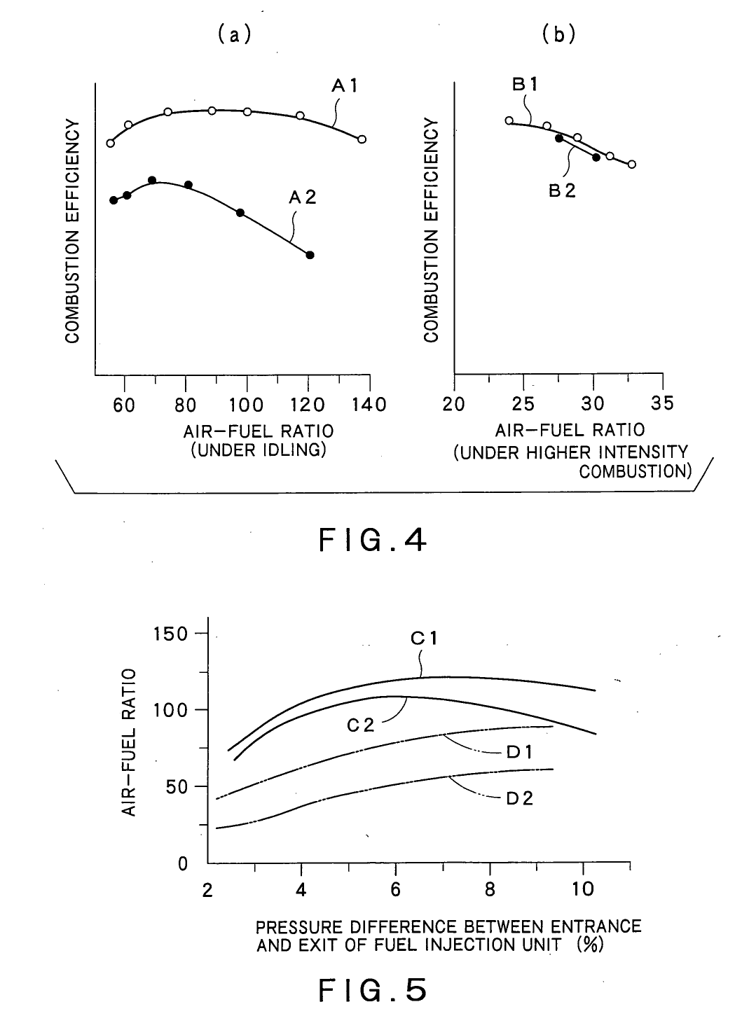

FIGS. 4 includes graphs (a) and (b) showing profiles of actually measured values for the combustion efficiency relative to the air-fuel ratio, under the idling operation, i.e., a load corresponding to approximately 7% of the full load, as well as under higher intensity combustion, in a gas turbine engine for an airplane. Curves A1, B1 respectively show profiling curves for the embodiment in which the width W is set at approximately 0.16D (W≈0.16D), while curves A2, B2 respectively show profiling curves when the width W is set at 0.10 (W=0.10). As is apparently seen from the graphs (a) and (b) in FIG. 4, if the width W is set at approximately 0.16D (W≈0.16D), the flame to be created in the diffusion combustion region 50 can be separated securely from the great amount of air 51 fed from the pre-mixture supply portion 4, due to the separation portion 43 and the separating air SA fed from the air curtain forming means 55, under a lower intensity combustion mode, such as the idling time. Therefore, it was found that significantly higher efficiency of fuel consumption can be provided, and that the combustion efficiency will not be lowered even under a higher intensity combustion mode.

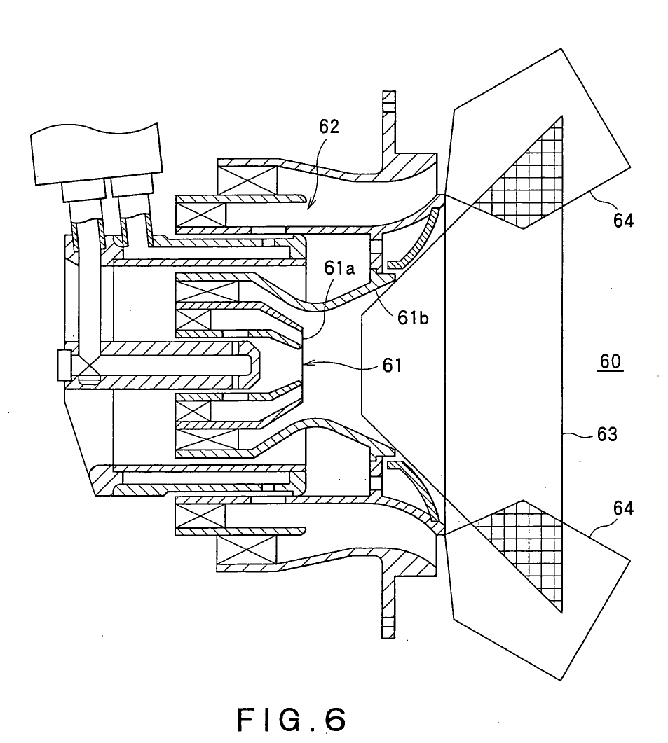

FIG. 5 is a graph showing test results for ignition and flame failure, wherein the horizontal axis designates the pressure difference between an entrance EN and an exit EX of each fuel injection unit 2 shown in FIG. 2, and the vertical axis expresses the air-fuel ratio. A curve C1 is a profiling curve expressing an upper limit of the air-fuel ratio, at which flame failure occurs in the combustor 1 of the embodiment, while a curve D1 is a profiling curve depicting a lower limit of the air-fuel ratio, at which the ignition is still possible in the same combustor 1. A curve C2 is a profiling curve expressing an upper limit of the air-fuel ratio, at which flame failure occurs in the conventional combustor shown in FIG. 6, while a curve D2 is a profiling curve showing a lower limit of the air-fuel ratio, at which the ignition is still possible in the same conventional combustor. According to the test results, in the combustor 1, as apparently seen from the comparison between the profiling curves C1 and C2, the flame failure will not occur until the air-fuel ratio is significantly-higher as compared with the case of the conventional combustor, due to the separation of the diffusion combustion region 50 from the great amount of air fed from the pre-mixture supply portion 4. In addition, as apparently seen from the comparison between the profiling curves D1 and D2, the ignition is still possible, even in the case of a significantly higher air-fuel ratio than that of the conventional combustor, i.e., even in a state wherein the fuel to be used is quite few.

Further preferred aspects of the present invention can be mentioned as follows.

### [First Aspect]

In the combustor 1 of a first aspect, the fuel spray portion 3 includes the cylindrical main body 20 having a bottom portion and adapted to inject the fuel F to be used for the diffusion combustion, the cylindrical inner circumferential wall 21 having a nozzle-like shape tapering off downstream and fitted around the main body 20, the cylindrical intermediate wall 22 having a nozzle-like shape tapering off downstream and arranged externally to the cylindrical inner circumferential wall 21, the diffusion passage portion 3b having a nozzle-like shape spreading like a trumpet and arranged externally to the cylindrical intermediate wall 22, the first inner swirler 24 disposed between the cylindrical inner circumferential wall 21 and the cylindrical intermediate wall 22, and the first outer swirler 27 disposed between the cylindrical intermediate wall 22 and the diffusion passage portion 3b.

### [Second Aspect]

In the combustor 1 of a second aspect, the effect to be provided by the first inner swirler 24 is controlled to be less than the effect to be provided by the first outer swirler 27.

### [Third Aspect]

In the combustor 1 of a third aspect, the fuel spray portion 3 includes the pre-mixture preparing chamber 37 and the pre-mixture chamber 42.

### [Fourth Aspect]

In the combustor 1 of a fourth aspect, the fuel spray portion 3 includes the inner block BL1 including the fuel spray portion and the outer block BL2 not including the fuel spray portion, wherein the inner block BL1 and outer block B2 can be separated from each other.

Although the invention has been described in its preferred embodiments with a certain degree of particularity, obviously many changes and variations are possible therein. It is therefore to be understood that the present invention may be practiced otherwise than as specifically described herein without departing from the scope and spirit thereof.

1. A combustor of a gas turbine engine comprising:
a fuel spray portion configured to spray a fuel so as to create a diffusion combustion region in a combustion chamber;
a pre-mixture supply portion configured to supply a pre-mixture gas including the fuel and an air so as to create a pre-mixture combustion region in the combustion chamber, the pre-mixture supply portion being positioned concentrically with the fuel spray portion so as to surround the fuel spray portion; and
an annular separation portion disposed between a downstream end of the fuel spray portion and a downstream end of the pre-mixture supply portion so as to separate the diffusion combustion region and the pre-mixture combustion region from each other.

2. The combustor of a gas turbine engine according to claim 1, wherein only the air is supplied from the pre-mixture supply portion into the diffusion combustion region while starting an operation of the engine and/or operating the engine under low intensity combustion.

3. The combustor of a gas turbine engine according to claim 1, further comprising air curtain forming means configured to inject a separating air between the diffusion combustion region and the pre-mixture combustion region through the annular separation portion so as to promote a separation between the regions.

4. The combustor of a gas turbine engine according to claim 1, wherein the annular separation portion has a width W in a radial direction, the pre-mixture supply portion includes an outer circumferential wall having an inner diameter D at a downstream end thereof, the width W being set between 0.13D to 0.25D.

5. The combustor of a gas turbine engine according to claim 1, wherein the fuel spray portion includes a fuel atomizing portion configured to atomize the fuel, and a diffusion passage portion disposed downstream of the fuel atomizing portion, the diffusion passage portion having a spreading trumpet-like shape and being configured to diffuse the fuel and the air.
